(19) United States
(12) Patent Application Publication
(10) Pub. No.: US 2026/0179186 A1
(43) Pub. Date: Jun. 25, 2026

(54) MOBILE DEVICE AND IMAGE PROCESSING METHOD

(71) Applicant: Realtek Semiconductor Corporation, Hsinchu (TW)

(72) Inventors: Xuanming LIU, Jiangsu Province (CN); Yifan ZHANG, Jiangsu Province (CN); Feihu WANG, Jiangsu Province (CN); Hao WANG, Jiangsu Province (CN); Jiaqi YAO, Jiangsu Province (CN); Yenchun KO, Hsinchu (TW)

(21) Appl. No.: 19/405,408

(22) Filed: Dec. 2, 2025

(30) Foreign Application Priority Data
Dec. 25, 2024 (CN) 202411924467.5

(51) Int. Cl. G06T 5/50; G06F 3/14; G06T 3/4007

(52) U.S. Cl. CPC G06T 5/50; G06F 3/14; G06T 3/4007; G06T 2207/10024; G06T 2207/20016

(57) ABSTRACT

This invention relates to a mobile device in which an image processing circuit is electrically connected to two buses. A processor sends an instruction to the image processing circuit through the second bus. The instruction indicates execution of an image processing procedure, including a geometric transformation process and a blending process, on input images. Upon receiving the instruction, the image processing circuit calculates the coordinates of input pixels based on the coordinate of an output pixel, thereby reading the input pixels from a memory through the first bus. The image processing circuit also executes the image processing procedure and writes the output pixel into the memory through the first bus.

### CROSS-REFERENCE TO RELATED APPLICATION

This application claims priority to China Application Serial Number 202411924467.5, filed Dec. 25, 2024, which is herein incorporated by reference in its entirety.

### BACKGROUND

### Field of Invention

The present disclosure relates to an image processing method applicable to a mobile device.

### Description of Related Art

Mobile devices (such as mobile phones, smart watches, and smart bracelets) are usually equipped with display panels. In order to present a user interface, it is often necessary to execute some image processing procedures (such as a blending process and a geometric transformation process) on the input image. The blending process is used to combine two or more images in a specific manner to create a new image. The blending process usually involves Alpha channel to control the blending degree of each pixel. The geometric transformation process includes a resizing transformation, which means changing (enlarging or reducing) the size of an image. These image processing procedures consume certain computing resources when executed, thereby affecting power consumption. Power consumption is particularly critical in mobile devices because of the limited battery capacity of mobile devices. In some conventional technologies, the above-mentioned image processing procedures are executed by a central processing unit or a graphics processing unit, but this consumes relatively more power consumption.

### SUMMARY

The present disclosure provides a mobile device. The mobile device includes a processor, a first bus, a memory, a bridge, a second bus, a display controller, and an image processing circuit. The first bus is electrically connected to the processor. The memory is electrically connected to the first bus. A first terminal of the bridge is electrically connected to the first bus. The second bus is electrically connected to a second terminal of the bridge. A bandwidth of the second bus is lower than a bandwidth of the first bus. The display controller is electrically connected to the second bus. The image processing circuit is electrically connected to the first bus and the second bus. The processor sends an instruction to the image processing circuit through the first bus, the bridge, and the second bus. The instruction indicates to execute an image processing procedure on at least one input image. The image processing procedure includes a geometric transformation process and a blending process. Upon receiving the instruction, the image processing circuit calculates a coordinate of at least one input pixel of the at least one input image based on a coordinate of an output pixel of an output image corresponding to the image processing procedure, thereby reading the at least one input pixel from the memory through the first bus. The image processing circuit executes the image processing procedure and writes the output pixel into the memory through the first bus.

In accordance with one or more embodiments of the present disclosure, the image processing circuit executes a bi-linear interpolation method to complete a resizing transformation included in the geometric transformation process. The number of the at least one input pixel is 4.

In accordance with one or more embodiments of the present disclosure, the image processing circuit pre-reads other pixel adjacent to the at least one input pixel from the memory based on an execution order.

In accordance with one or more embodiments of the present disclosure, after generating the output image, the image processing circuit automatically generates a next output image through a contiguous mode, an auto-reload mode, or a linked list mode.

In accordance with one or more embodiments of the present disclosure, the image processing circuit includes a first port, a second port, plural image layer registers, a layer-to-channel converter, plural global registers, a selection circuit, a computing circuit, a pixel format converter, an input buffer, and an output buffer. The first port is connected to the first bus. The second port is connected to the second bus. The image layer registers are connected to the second port. The layer-to-channel converter is connected to the image layer registers for controlling plural direct memory access channels. The global registers are connected to the second port. The selection circuit is connected to the global registers and the layer-to-channel converter. The computing circuit is connected to the selection circuit. The pixel format converter is connected to the computing circuit. The input buffer is connected between the selection circuit and the first port. The output buffer is connected between the pixel format converter and the first port.

In accordance with one or more embodiments of the present disclosure, the number of the at least one input image is greater than or equal to 2. The computing circuit includes plural blending units. Each of the blending units receives two of the at least one input image and executes the blending process.

In accordance with one or more embodiments of the present disclosure, the computing circuit includes plural blending units. One of the blending units executes the blending process on the at least one input image and a pure color image.

In accordance with one or more embodiments of the present disclosure, the selection circuit pre-processes a setting grayscale value in the at least one input image based on a preset grayscale value.

In accordance with one or more embodiments of the present disclosure, the pixel format converter is configured to convert the output pixel into a preset format.

In accordance with one or more embodiments of the present disclosure, the processor further sends a suspension instruction, a resumption instruction or an abortion instruction to the image processing circuit through the first bus, the bridge and the second bus.

In accordance with one or more embodiments of the present disclosure, the first bus is an Advanced eXtensible Interface (AXI), and the second bus is an advanced peripheral bus (APB).

In accordance with one or more embodiments of the present disclosure, the geometric transformation process includes at least one of the following: a resizing transformation, a rotation transformation, a reflection transformation, a shear transformation, and a perspective transformation.

The present disclosure further provides an image processing method applicable to an image processing circuit of a mobile device. The image processing method includes: receiving an instruction from a processor through a second bus; upon receiving the instruction, calculating a coordinate of at least one input pixel of at least one input image based on a coordinate of an output pixel of an output image corresponding to an image processing procedure, thereby reading the at least one input pixel from a memory through a first bus; and executing the image processing procedure and writing the output pixel into the memory through the first bus. The processor is electrically connected to a first bus. The first bus is electrically connected to a first terminal of a bridge. A second terminal of the bridge is electrically connected to the second bus. The memory is electrically connected to the first bus. A bandwidth of the second bus is lower than a bandwidth of the first bus. The instruction indicates to execute the image processing procedure on the at least one input image. The image processing procedure includes a geometric transformation process and a blending process.

In accordance with one or more embodiments of the present disclosure, the image processing method further includes: changing a setting grayscale value in the at least one input image to a preset grayscale value.

In order to make the above features and advantages of the present disclosure more apparent and understandable, the following embodiments of the present disclosure, together with the accompanying drawings, are described in detail below.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram showing the architecture of a mobile device according to one embodiment.

FIG. 2 is a schematic diagram illustrating a blending process according to one embodiment.

FIG. 3 is a schematic diagram illustrating bi-linear interpolation according to one embodiment.

FIG. 4 is a schematic diagram showing internal structure of an image processing circuit according to one embodiment.

FIG. 5 is a flow chart illustrating an image processing method according to one embodiment.

### DETAILED DESCRIPTION

Specific embodiments of the present disclosure are further described in detail below with reference to the accompanying drawings. However, the embodiments described are not intended to limit the present disclosure and it is not intended for the description of operations to limit the order of implementation. The terms “first” and “second” used in the specification should be understood as identifying units or data described by the same terminology, and do not refer to a particular order or sequence. In this disclosure, when describing that two elements are electrically connected to each other, other element(s) (such as a bridge, a resistor, and/or a switch, etc.) may be disposed between these two elements.

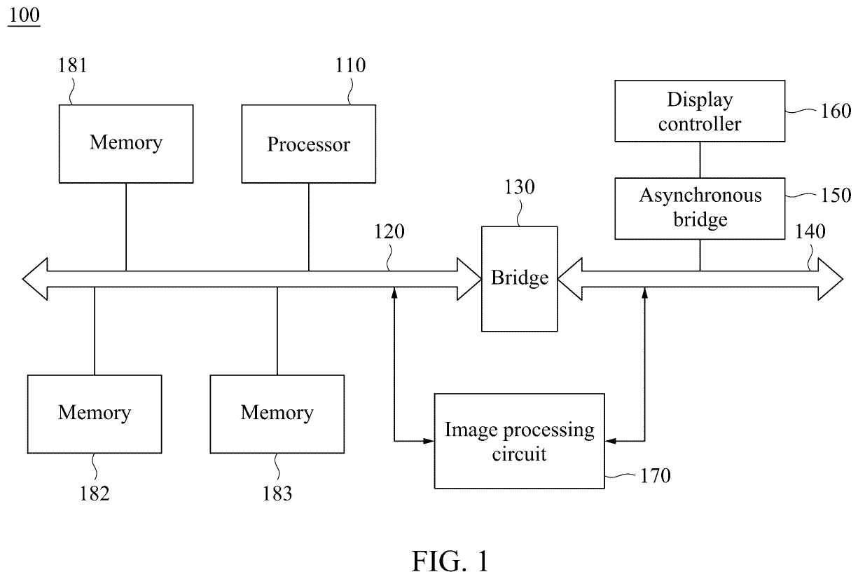

FIG. 1 is a schematic diagram showing the architecture of a mobile device 100 according to one embodiment. Referring to FIG. 1, the mobile device 100 is, for example, a smart watch, a smart bracelet, a mobile phone, or other mobile device. The mobile device 100 includes a processor 110, a first bus 120, a bridge 130, a second bus 140, an asynchronous bridge 150, a display controller 160, an image processing circuit 170, and memories 181˜183.

The processor 110 is, for example, a central processing unit (CPU) or a microprocessor, and is electrically connected to the first bus 120. The memories 181˜183 are also electrically connected to the first bus 120. In this embodiment, the memories 181˜183 belong to different types. For example, the memory 181 is a static random access memory (SRAM), the memory 182 is a flash memory (Flash), and the memory 183 is a Pseudo SRAM, but the present disclosure is not limited thereto.

The first bus 120 is electrically connected to a first terminal of the bridge 130, and the second bus 140 is electrically connected to a second terminal of the bridge 130. The bridge 130 transmits data on the first terminal (or the second terminal) to the second terminal (or the first terminal). In this embodiment, the bandwidth of the second bus 140 is lower than the bandwidth of the first bus 120. For example, the first bus 120 is an Advanced eXtensible Interface (AXI), and the second bus 140 is an advanced peripheral bus (APB), but the present disclosure is not limited thereto. The asynchronous bridge 150 is electrically connected to the second bus 140, and the display controller 160 is electrically connected to the asynchronous bridge 150. The display controller 160 may be further electrically connected to a display (not shown). Since the clock or timing (e.g., the frame rate) of the display controller 160 is different from the clock or timing of the second bus 140, the asynchronous bridge 150 is required for data transmission.

The image processing circuit 170 is electrically connected to the first bus 120 and the second bus 140 to execute one or more image processing procedures. The image processing procedures may include a geometric transformation process and a blending process. In some embodiments, the image processing circuit 170 can be served as a circuit module and integrated into a system on a chip (SOC). Compared to the conventional technology in which the processor or the graphics processing unit executes these image processing procedures, the image processing circuit 170 has the advantages of low cost and small area. The geometric transformation process may include at least one of the following: a resizing transformation, a rotation transformation, a reflection transformation, a shear transformation, and a perspective transformation.

Specifically, the processor 110 sends an instruction to the image processing circuit 170 via the first bus 120, the bridge 130, and the second bus 140 in sequence. This instruction instructs to execute the above-mentioned image processing procedure on one or more input images, and these input images can be stored in any one of the memories 181˜183. Upon receiving the instruction, the image processing circuit 170 calculates the coordinates of the input pixels required by the input image according to the coordinates of the output pixels in the output image (i.e., the image after the blending process and the geometric transformation process) corresponding to the image processing procedure, thereby reading the input pixels from the memories 181˜183 through the first bus 120. In the prior art, if a graphics processing unit is used, the internal memory of the graphics processing unit will be used to temporarily store the input image. However, this known method requires a larger internal memory space, and may even lead to insufficient internal memory space. On the contrary, in this embodiment, the image processing circuit 170 does not need such a large internal memory space to store the entire (or multiple) input images. The coordinates of the input pixels are first inferred from the coordinates of the output pixels, and then the required input pixels are read from the memories 181˜183. These image processing procedures can save memory costs. In addition, the image processing circuit 170 is electrically connected to the first bus 120 and the second bus 140 of different bandwidths, in which the second bus 140 of lower bandwidth is used to transmit the instruction, and the first bus 120 of higher bandwidth is used to transmit the images. Such allocation can improve overall efficiency. After the image processing circuit 170 executes the image processing procedure, the corresponding output pixels are generated. Then, the corresponding output pixels can be written into one of the memories 181˜183 through the first bus 120.

Here, various functions of the image processing circuit 170 are described. The image processing circuit 170 adopts a RGB format as input and output, and also supports different RGB modes, such as RGB565 mode, RGB888 mode, etc., or may also support the A8 format. In other embodiments, the image processing circuit 170 may also adopt another color format, such as YUV format. The image processing circuit 170 may also perform format conversion on the input image or the output image, for example, converting the input image or the output image into a different RGB format or a preset format. The preset format may be a specific RGB format, but the present disclosure is not limited thereto. The image processing circuit 170 also supports a color key, which can change a setting grayscale value (also called a key) of the input image into a preset grayscale value (e.g., 0). In other words, all pixels of the input image that have the same value with key will be changed to the preset grayscale value (e.g., 0). In other words, the image processing circuit 170 may perform the color key to pre-process the setting grayscale value in the input image according to the preset grayscale value, for example, to change the setting grayscale value into the preset grayscale value.

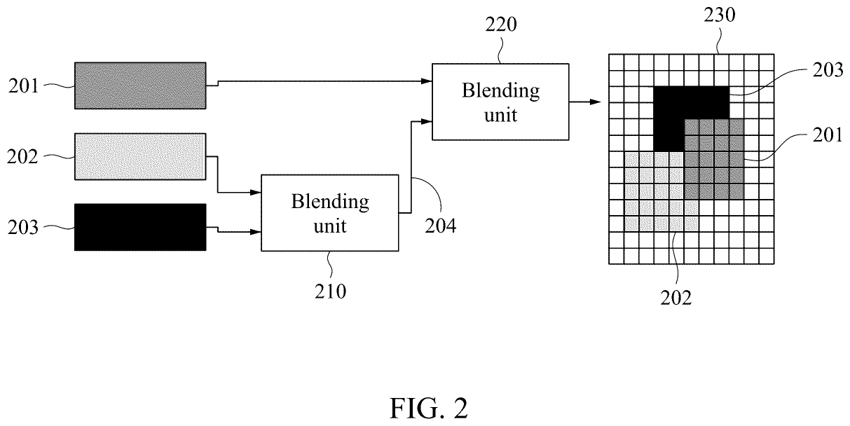

The image processing circuit 170 also supports alpha masking, and can pre-process alpha of each input pixel. For example, for the grayscale value Aₘ of the input pixel, a calculation of Aₘ×A_{c}/255 may be performed, where A_{c} is a preset alpha. Another type of alpha is alpha of the pixel, which is also served as a weight to calculate the weighted sum the grayscale values of the two input images during the blending process. FIG. 2 is a schematic diagram illustrating a blending process according to one embodiment. Referring to FIG. 2, the image processing circuit 170 includes two blending units 210 and 220. There are three input images, represented as image layers 201˜203. The first input of the blending unit 210 is the image layer 202, and the second input of the blending unit 210 is the image layer 203. The output 204 of the blending unit 210 is served as one input of the blending unit 220, and the other input of the blending unit 220 is the image layer 201. The blending unit 220 generates an output image 230. Two image layers inputted into the blending unit are considered as the foreground and the background, respectively. In this embodiment, the blending unit performs the blending process on plural received input images. In one embodiment, the operation of a single blending unit can be expressed as the following mathematical formula 1.

$${C}_{R} = \frac{{C}_{F G} * {A}_{F G} + {C}_{B G} * ( 255 - {A}_{F G} )}{255} ; \qquad Mathematical formula 1$$

$${A}_{R} = \frac{{A}_{F G} * {A}_{F G} + {A}_{B G} * ( 255 - {A}_{F G} )}{255} .$$

Here C_{FG} represents the color component (such as the grayscale value of red, green or blue) of the foreground. C_{BG} represents the color component (such as the grayscale value of red, green or blue) of the background. A_{FG} represents the alpha of the foreground. A_{BG} is the alpha of the background. C_{R} is the color component outputted by the blending unit. A_{R} is the alpha outputted by the blending unit.

In some embodiments, the input of the blending unit 210 or 220 may also be a pure color image. For example, the processor 110 specifies a pure color grayscale value, and each pixel in the pure color image has a pure color grayscale value. Assuming that the image layer 203 is a pure color image, the blending unit 210 performs the blending process on the input image (i.e., the image layer 202) and the pure color image (i.e., the image layer 203). In such example, the image processing circuit 170 does not need to read the pure color image from the memories 181˜183, and only needs to replace the grayscale value C_{FG} or C_{BG} in the above mathematical formula 1 with the pure color grayscale value, which is equivalent to performing the blending process on the input image and the pure color image. In other embodiments, the image processing circuit 170 may also have more than two blending units, but the present disclosure is not limited thereto.

The image processing circuit 170 also provides a multi-frame mechanism, which can adopt a contiguous mode, an auto-reload mode, or a linked list mode. After the image processing circuit 170 generates an output image, the next output image can be automatically processed through one of the above modes. For example, when the linked list mode is adopted, the processor 110 transmits a list to the image processing circuit 170. This list records plural nodes, and each node includes a starting point of the frame and a pointer to the next node. Those with ordinary knowledge in the art should understand the above-mentioned modes, and are not described here. In this way, the processor 110 does not need to send the corresponding instruction for each frame, and the image processing circuit 170 will automatically execute the image processing procedures for multiple frames.

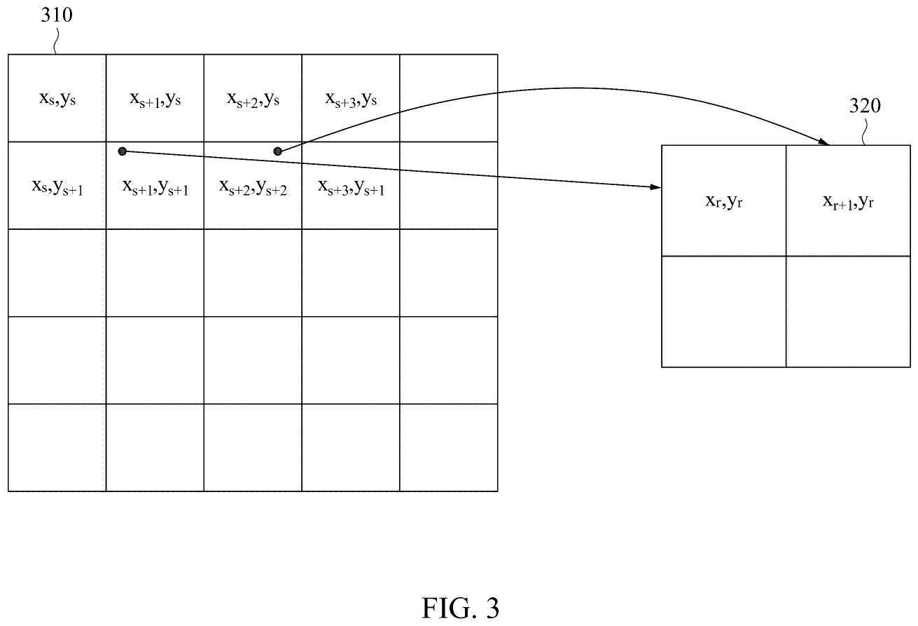

When executing the resizing transformation included in the geometric transformation process, the image processing circuit 170 adopts the bi-linear interpolation. The bi-linear interpolation calculates the grayscale value of an output pixel according to the grayscale values of four input pixels. FIG. 3 is a schematic diagram illustrating the bi-linear interpolation according to one embodiment. Referring to FIG. 3, in this example, an input image 310 is reduced to generate an output image 320. According to the reduction ratio, the image processing circuit 170 can conversely deduce the coordinates (i.e., (xₛ, yₛ), (xₛ₊₁, yₛ), (xₛ₊₁, yₛ₊₁), and (xₛ₊₁, yₛ₊₁)) of the four input pixels required for the input image 310 from the coordinate (i.e., (xᵣ, yᵣ)) of the output pixel. The bi-linear interpolation can be performed based on these four input pixels. For example, when the reduction ratio is 1.3, the coordinate (i.e., (xᵣ, yᵣ)) of the output pixel is multiplied by the reduction ratio to obtain (1.3×xᵣ, 1.3×yᵣ). Since such coordinate may not be integers, the four pixels closest to (1.3×xᵣ, 1.3×yᵣ) can be found as input pixels. In other embodiments, the reduction ratio may also be an integer, and the present disclosure is not limited thereto.

In some embodiments, the image processing circuit 170 may also pre-read other pixels adjacent to the aforementioned four input pixels from the memories 181˜183 according to the execution order. For example, in this embodiment, the execution order is to process one row and then process the next row. The coordinate of the next output pixel is (xᵣ₊₁, yᵣ). After calculation, it is known that four input pixels located at coordinates (xₛ₊₂, yₛ), (xₛ₊₃, yₛ), (xₛ₊₂, yₛ₊₁), and (xₛ₊₃, yₛ₊₁) are required. Therefore, the image processing circuit 170 can pre-read the subsequent four input pixels while generating the first output pixel. In some embodiments, not only the subsequent four input pixels may be read, but also other pixels located at consecutive addresses of the four input pixels may be read together. For example, other pixels located at the same coordinates (xₛ₊₁, yₛ), (xₛ₊₁, yₛ₊₁) may be pre-read, where i>=2.

The image processing circuit 170 can support secure access and non-secure access. The image processing circuit 170 may also support operation of suspending, resuming or aborting during processing. In other words, the processor 110 may also send the suspension instruction, the resumption instruction and the abortion instruction to the image processing circuit 170 through the first bus 120, the bridge 130 and the second bus 140.

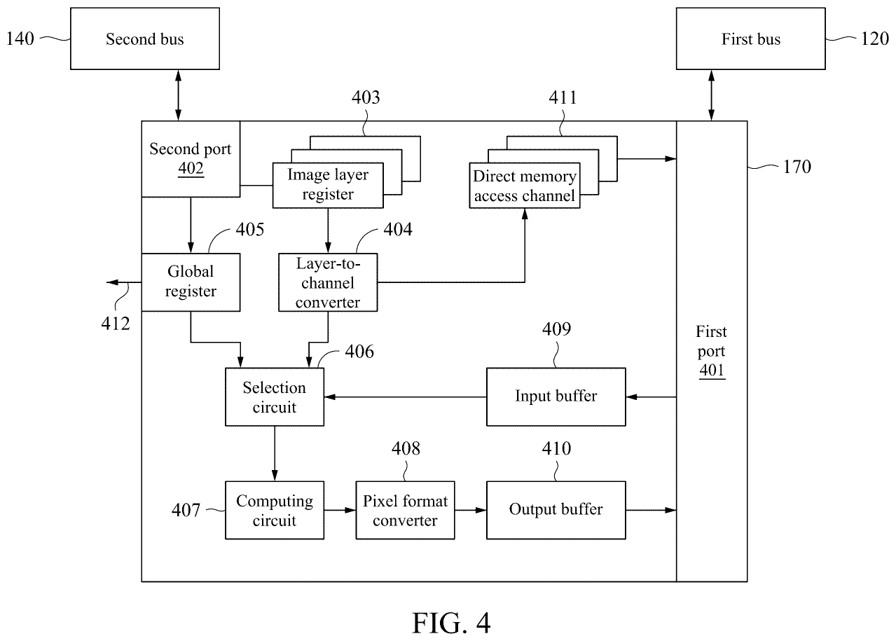

FIG. 4 is a schematic diagram showing the internal structure of the image processing circuit 170 according to one embodiment. Referring to FIG. 4, the image processing circuit 170 includes a first port 401, a second port 402, plural image layer registers 403, a layer-to-channel converter 404, a global register 405, a selection circuit 406, a computing circuit 407, a pixel format converter 408, an input buffer 409, and an output buffer 410.

The first port 401 is connected to the first bus 120. For example, the first port 401 complies with the specification of the AXI bus. The second port 402 is connected to the second bus 140. For example, the second port 402 complies with the specification of the APB bus. It is worth noting that the positions of the first bus 120 and the second bus 140 in FIG. 4 are different from those in FIG. 1, but this does not affect the following description.

The image layer register 403 is connected to the second port 402. The image layer register 403 stores various information related to the image processing procedure. For example, the image layer register 403 can store the size of the input image, the position of the input image, the size of the output image, the starting position of the image layer when performing the blending process, the setting alpha, the setting grayscale value, the pure color grayscale value, etc.

In this embodiment, regarding the instruction sent by the processor 110, the input image is regarded as an image layer. However, when accessing the memory subsequently, the image layer must be converted into direct memory access channels. The layer-to-channel converter 404 is connected to the image layer register 403 for controlling plural direct memory access channels 411. It is worth noting that these direct memory access channels 411 are logical and not physical. The layer-to-channel converter 404 converts the behavior of reading pixels of the input image into the behavior of the corresponding direct memory access channels, thereby utilizing the direct memory access mechanism to read the corresponding pixels from the memory. The read pixels are temporarily stored in the input buffer 409.

The global register 405 is connected to the second port 402. The global register 405 stores global information. For example, the global information includes information on whether to execute the image processing procedure (i.e., the blending process and the geometric transformation process), or information that the processor 110 sends the suspension instruction, the resumption instruction, or the abortion instruction. The global information may also include information on whether to execute the contiguous mode, the auto-reload mode, or the linked list mode. In some embodiments, the image processing circuit 170 further transmits/receives a signal 412, and the signal 412 represents the interruption. For example, the interruption may be sent after plural images are processed.

The selection circuit 406 is connected to the global register 405 and the layer-to-channel converter 404. The selection circuit 406 converts pixel formats, performs color key, or determines input pixels to be read. The description of color key and coordinates of the input pixels have been described above and will not be repeated here. In some embodiments, the selection circuit 406 may pre-process the setting grayscale value of at least one input image according to a preset grayscale value.

The computing circuit 407 is connected to the selection circuit 406. The computing circuit 407 includes the above-mentioned blending unit and the circuit for performing the bi-linear interpolation. The blending process and the geometric transformation process have been described above. The pixel format converter 408 is connected to the computing circuit 407 for performing conversion of pixel format. In some embodiments, the pixel format converter 408 converts the output pixels into a preset format, but the present disclosure does not limited the type of the preset format.

The input buffer 409 is connected between the selection circuit 406 and the first port 401. The input buffer 409 is used for storing the input pixels. The output buffer 410 is connected between the pixel format converter 408 and the first port 401. The output buffer 410 is used for storing the output pixels. In some embodiments, the input buffer 409 and the output buffer 410 have a first-in-first-out (FIFO) mechanism.

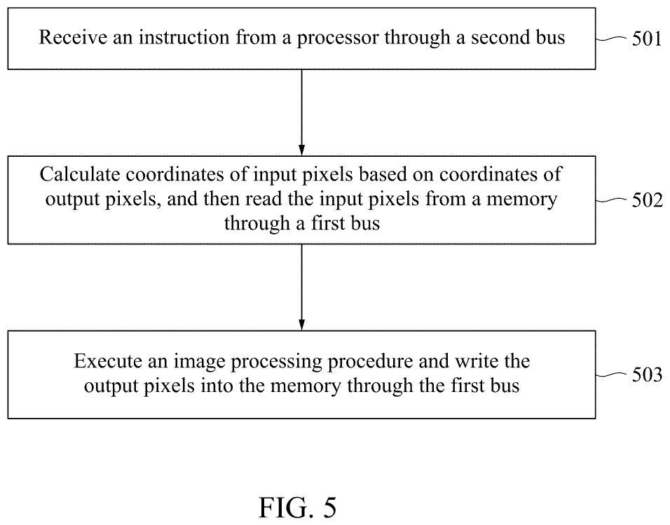

FIG. 5 is a flow chart illustrating an image processing method according to one embodiment. Referring to FIG. 5, the image processing method is executed by the image processing circuit 170. In Step 501, the instruction is received from the processor 110 via the second bus 140. In Step 502, the coordinates of the input pixels are calculated according to the coordinates of the output pixels, thereby reading the input pixels from the memory through the first bus 120. In Step 503, the image processing procedure is executed, and the output pixels are written to the memory via the first bus 120. The Steps in FIG. 5 have been described in detail above and will not be repeated here. It should be noted that each step in FIG. 5 can be implemented as plural program codes or plural circuits, and the present invention is not limited thereto. In addition, the image processing method of FIG. 5 can be used in conjunction with the above embodiments or can be used alone. In other words, other step(s) can be added between adjacent two of the steps of FIG. 5.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A mobile device, comprising:
a processor;
a first bus electrically connected to the processor;
a memory electrically connected to the first bus;
a bridge, wherein a first terminal of the bridge is electrically connected to the first bus;
a second bus electrically connected to a second terminal of the bridge, wherein a bandwidth of the second bus is lower than a bandwidth of the first bus;
a display controller electrically connected to the second bus; and
an image processing circuit electrically connected to the first bus and the second bus;
wherein the processor is configured to send an instruction to the image processing circuit through the first bus, the bridge, and the second bus, wherein the instruction is configured to indicate to execute an image processing procedure on at least one input image, wherein the image processing procedure includes a geometric transformation process and a blending process;
wherein upon receiving the instruction, the image processing circuit is configured to calculate a coordinate of at least one input pixel of the at least one input image based on a coordinate of an output pixel of an output image corresponding to the image processing procedure, thereby reading the at least one input pixel from the memory through the first bus;
wherein the image processing circuit is configured to execute the image processing procedure and write the output pixel into the memory through the first bus.

2. The mobile device of claim 1, wherein the image processing circuit is configured to execute a bi-linear interpolation method to complete a resizing transformation included in the geometric transformation process, wherein number of the at least one input pixel is 4.

3. The mobile device of claim 2, wherein the image processing circuit is configured to pre-read other pixel adjacent to the at least one input pixel from the memory based on an execution order.

4. The mobile device of claim 3, wherein after generating the output image, the image processing circuit automatically generates a next output image through a contiguous mode, an auto-reload mode, or a linked list mode.

5. The mobile device of claim 1, wherein the image processing circuit comprises:
a first port connected to the first bus;
a second port connected to the second bus;
a plurality of image layer registers connected to the second port;
a layer-to-channel converter connected to the image layer registers for controlling a plurality of direct memory access channels;
a plurality of global registers connected to the second port;
a selection circuit connected to the global registers and the layer-to-channel converter;
a computing circuit connected to the selection circuit;
a pixel format converter connected to the computing circuit;
an input buffer connected between the selection circuit and the first port; and
an output buffer connected between the pixel format converter and the first port.

6. The mobile device of claim 5, wherein number of the at least one input image is greater than or equal to 2, wherein the computing circuit includes a plurality of blending units, wherein each of the blending units is configured to receive two of the at least one input image and execute the blending process.

7. The mobile device of claim 5, wherein the computing circuit includes a plurality of blending units, one of the blending units is configured to execute the blending process on the at least one input image and a pure color image.

8. The mobile device of claim 5, wherein the selection circuit is configured to pre-process a setting grayscale value in the at least one input image based on a preset grayscale value.

9. The mobile device of claim 5, wherein the pixel format converter is configured to convert the output pixel into a preset format.

10. The mobile device of claim 5, wherein the processor is further configured to send a suspension instruction, a resumption instruction or an abortion instruction to the image processing circuit through the first bus, the bridge and the second bus.

11. The mobile device of claim 1, wherein the first bus is an Advanced eXtensible Interface (AXI), and the second bus is an advanced peripheral bus (APB).

12. The mobile device of claim 1, wherein the geometric transformation process includes at least one of following: a resizing transformation, a rotation transformation, a reflection transformation, a shear transformation, and a perspective transformation.

13. An image processing method applicable to an image processing circuit of a mobile device, comprising:
receiving an instruction from a processor through a second bus, wherein the processor is electrically connected to a first bus, wherein the first bus is electrically connected to a first terminal of a bridge, wherein a second terminal of the bridge is electrically connected to the second bus, wherein a memory is electrically connected to the first bus, wherein a bandwidth of the second bus is lower than a bandwidth of the first bus, wherein the instruction is configured to indicate to execute an image processing procedure on at least one input image, wherein the image processing procedure includes a geometric transformation process and a blending process; and
upon receiving the instruction, calculating a coordinate of at least one input pixel of the at least one input image based on a coordinate of an output pixel of an output image corresponding to the image processing procedure, thereby reading the at least one input pixel from the memory through the first bus; and
executing the image processing procedure and writing the output pixel into the memory through the first bus.

14. The image processing method of claim 13, further comprising:
executing a bi-linear interpolation method to complete a resizing transformation included in the geometric transformation process, wherein number of the at least one input pixel is 4.

15. The image processing method of claim 14, further comprising:
pre-reading other pixel adjacent to the at least one input pixel from the memory based on an execution order.

16. The image processing method of claim 13, further comprising:
after generating the output image, automatically generating a next output image through a contiguous mode, an auto-reload mode, or a linked list mode.

17. The image processing method of claim 13, wherein number of the at least one input image is greater than or equal to 2, wherein the image processing method further comprises:
receiving two of the at least one input image through a blending unit and executing the blending process.

18. The image processing method of claim 13, further comprising:
executing the blending process on the at least one input image and a pure color image through a blending unit.

19. The image processing method of claim 13, further comprising:
changing a setting grayscale value in the at least one input image to a preset grayscale value.

20. The image processing method of claim 13, wherein the first bus is an Advanced eXtensible Interface (AXI), and the second bus is an advanced peripheral bus (APB).
